(19) United States
(12) Patent Application Publication
(10) Pub. No.: US 2012/0066396 A1
(43) Pub. Date: Mar. 15, 2012

(54) APPARATUS AND METHOD FOR SUPPORTING PERIODIC MULTICAST TRANSMISSION IN MACHINE TO MACHINE COMMUNICATION SYSTEM

(75) Inventors: Hyun-Jeong KANG, Seoul (KR); Hyun-Kyu YU, Yongin-si (KR); Chi-Woo LIM, Suwon-si (KR); Rakesh TAORI, Suwon-si (KR)

(73) Assignee: SAMSUNG ELECTRONICS CO. LTD., Suwon-si (KR)

(21) Appl. No.: 13/225,711

(22) Filed: Sep. 6, 2011

(30) Foreign Application Priority Data
Sep. 10, 2010 (KR) 10-2010-0088926

(51) Int. Cl. G06F 15/173

(52) U.S. Cl. 709/226

(57) ABSTRACT

A method and apparatus for effectively transmitting periodically generated group data of a serving group in a Machine to Machine (M2M) communication system are provided. A method includes determining whether a persistent resource for group data of an M2M communication service group is allocated, if the persistent resource is not allocated, configuring the persistent resource for the group data and transmitting allocation information for the persistent resource to at least one Subscriber Station (SS) registered to the service group, and multicasting the group data to the at least one SS by using the persistent resource.

### PRIORITY

This application claims the benefit under 35 U.S.C. §119(a) of a Korean patent application filed in the Korean Intellectual Property Office on Sep. 10, 2010 and assigned Serial No. 10-2010-0088926, the entire disclosure of which is hereby incorporated by reference.

### BACKGROUND OF THE INVENTION

1. Field of the Invention

The present invention relates to a machine to machine communication system. More particularly, the present invention relates to an apparatus and method for supporting periodic group data communication in a machine to machine communication system.

2. Description of the Related Art

Research is ongoing on a Machine to Machine (M2M) communication service that supports data communication between devices involving limited or no human interactions. The M2M communication service has drawn attention for the purpose of reducing device management costs by using automatic control or communication. The M2M communication service is expected to be applicable to fleet management of a vehicle and components equipped in the vehicle, smart metering, home automation, heath care, etc.

In the M2M communication system, a system designer should consider a device that transmits and receives limited data only in a limited time period unlike in a subscriber station of a typical communication system. For example, a device that performs smart metering may transmit a measurement value with a specific time interval, for example, once a month, to a smart meter server, or may receive metering information once a day from the smart meter server. In the case of a health care device, the health care device can maintain the latest health care information by receiving health care information once a day from a heath case server.

A situation occurs in which limited data is transmitted or received depending on a specific period according to a purpose and usage of the subscriber station in the M2M communication system. If multiple subscriber stations have the same type, the subscriber stations transmit or receive the same data depending on a specific period. Since it is expected that the plurality of subscriber stations will transmit or receive the same data at a determined time in this case, there is a need to provide a method for effectively performing communication by taking advantage of this characteristic.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for effectively performing communication by using a periodic data transmission/reception property of Subscriber Stations (SSs) in a Machine to Machine (M2M) communication system.

Another aspect of the present invention is to provide an apparatus and method for periodically transmitting data to a plurality of SSs in an M2M communication system.

Another aspect of the present invention is to provide an apparatus and method for periodically allocating resources to a plurality of SSs in an M2M communication system.

In accordance with an aspect of the present invention, a method of operating a Base Station (BS) in an M2M communication system is provided. The method includes determining whether a persistent resource for group data of an M2M communication service group is allocated, if the persistent resource is not allocated, configuring the persistent resource for the group data and transmitting allocation information for the persistent resource to at least one SS registered to the service group, and multicasting the group data to the at least one SS by using the persistent resource.

In accordance with another aspect of the present invention, a method of operating an SS in an M2M communication system is provided. The method includes receiving service group information according to an M2M communication service group registration procedure, upon receiving allocation information for a persistent resource for group data of the service group, storing the allocation information for the persistent resource, and upon arrival of a period including the persistent resource, receiving the group data by using the persistent resource.

In accordance with another aspect of the present invention, a BS apparatus in an M2M communication system is provided. The apparatus includes a controller for determining whether a persistent resource for group data of an M2M communication service group is allocated, and a modem for configuring the persistent resource for the group data if the persistent resource is not allocated, for transmitting allocation information for the persistent resource to at least one SS registered to the service group, and for multicasting the group data to the at least one SS by using the persistent resource.

In accordance with another aspect of the present invention, an SS apparatus in an M2M communication system is provided. The apparatus includes a modem for receiving service group information according to an M2M communication service group registration procedure, a storage unit for storing allocation information for a persistent resource upon receiving the allocation information for the persistent resource for group data of the service group, and a controller for receiving the group data by using the persistent resource upon arrival of a period including the persistent resource.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic view illustrating a Machine to Machine (M2M) communication system according to an exemplary embodiment of the present invention;

FIG. 2 illustrates a process of exchanging a signal between a Base Station (BS) and a Subscriber Station (SS) which transmits and receives group data in an M2M communication system according to an exemplary embodiment of the present invention;

FIG. 3 illustrates a process of exchanging a signal between a server and a BS which transmits and receives group data in an M2M communication system according to an exemplary embodiment of the present invention;

FIG. 4 is a flowchart illustrating an operation of a BS in an M2M communication system according to a first exemplary embodiment of the present invention;

FIG. 5 is a flowchart illustrating a process of operating a BS in an M2M communication system according to a second exemplary embodiment of the present invention;

FIG. 6 is a flowchart illustrating a process of operating an SS in an M2M communication system according to a first exemplary embodiment of the present invention;

FIG. 7 is a flowchart illustrating a process of operating an SS in an M2M communication system according to a second exemplary embodiment of the present invention;

FIG. 8 is a block diagram of a BS in an M2M communication system according to an exemplary embodiment of the present invention; and

FIG. 9 is a block diagram of an SS in an M2M communication system according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention described below relate to a technique for transmitting data periodically to a plurality of subscriber stations in a machine to machine communication system.

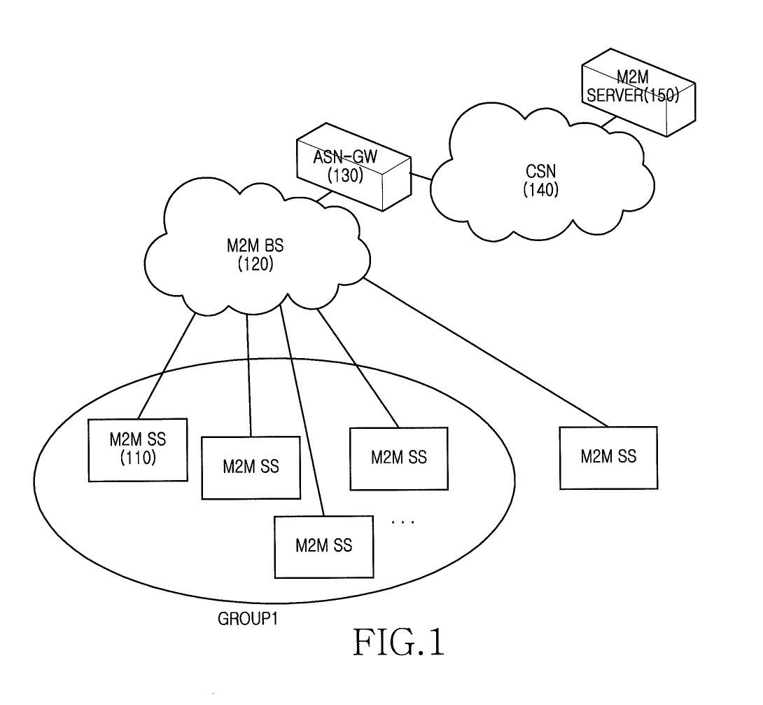

FIG. 1 is a schematic view illustrating a Machine to Machine (M2M) communication system according to an exemplary embodiment of the present invention.

Referring to FIG. 1, the M2M communication system includes an M2M Subscriber Station (SS) 110 that supports M2M communication, an M2M Base Station (BS) 120 that supports M2M communication, an Access Service Network GateWay (ASN-GW) 130, a Connected Service Network (CSN) 140, and an M2M server 150.

The M2M SS 110 is a device that performs communication without intervention of a user, and is an SS equipped with an application program required for M2M communication. The M2M BS 120 and the ASN-GW 130 provide a radio access point for communication between the M2M SS 110 and the M2M server 150. The M2M BS 120 controls a radio resource for communication between the M2M SS 110 and the M2M server 150. The CSN 140 provides a user-side connection service to the M2M SS 110. The M2M server 150 performs communication with one or more M2M SSs 110. The M2M server 150 includes an application program required for the M2M communication, and has an interface through which the user accesses the M2M server 150. Although the M2M server 150 is depicted as a separate entity from the CSN 140 in FIG. 1, the M2M server 150 may be included in the CSN 140.

In the M2M communication system, a radio interface between the M2M SS 110 and the M2M BS 120 may conform to a conventional communication protocol or may conform to a communication protocol devised for the M2M communication system. For example, an Institute of Electrical and Electronics Engineers (IEEE) 802.16 communication system protocol may be employed. In this case, the M2M SS 110 operates similarly to a mobile station defined in the IEEE 802.16 communication system. The exemplary embodiments of the present invention described below are based on a radio interface based on Orthogonal Frequency Division Multiplexing (OFDM)/Orthogonal Frequency Division Multiplex Access (OFDMA) for example.

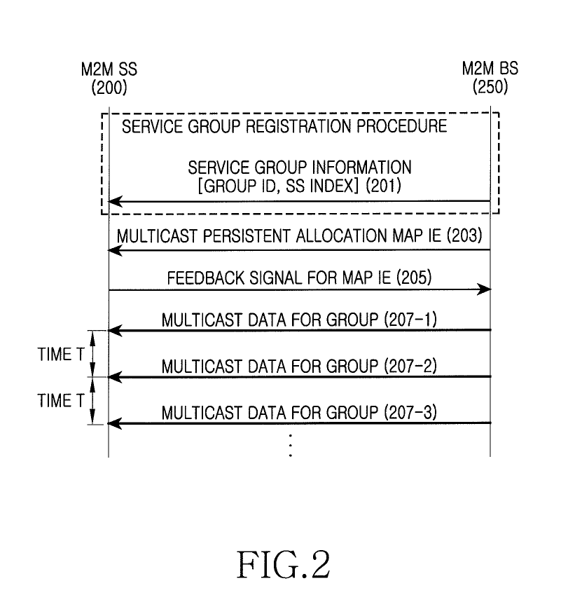

FIG. 2 illustrates a process of exchanging a signal between a BS and an SS which transmit and receive group data in an M2M communication system according to an exemplary embodiment of the present invention.

Referring to FIG. 2, an M2M SS 200 receives information of an M2M communication service group from an M2M BS 250 while performing a process of registering to the M2M communication service group in step 201. The service group registration procedure is a procedure in which the M2M SS 200 is registered to the group to receive a service provided from an M2M server to the M2M BS 250, and is performed by inserting information that indicates service group registration into a message transmitted in a network entry procedure or a service flow generation procedure. For example, the service group registration procedure may employ a registration message used in the network entry or a Dynamic Service Addition Request (DSA-REQ) message used in a service flow creation. The information of the M2M communication service group includes an IDentifier (ID) of the M2M communication service group and an index allocated to the M2M SS 200. The index is used to identify the M2M SS 200 included in the M2M communication service group, and is used to identify a location of a feedback channel of the M2M SS 200 among feedback channels allocated to SSs belonging to the group. For example, the feedback channel may be a Hybrid Automatic Repeat reQuest (HARQ) channel.

For group data transmitted to the M2M communication service group to which the M2M SS 200 is registered, the M2M BS 250 uses a resource periodically allocated in a fixed location. The ‘resource periodically allocated in the fixed location’ denotes a ‘persistent resource’ for convenience of explanation. The M2M BS 250 transmits persistent resource allocation information to the M2M SS 200 and other SSs belonging to the M2M communication service group in step 203. The persistent resource allocation information may be referred to as a multicast persistent allocation MAP Information Element (IE). When multicast data is transmitted depending on a specific period to all SSs belonging to the M2M communication service group, the persistent resource allocation information is used to indicate allocation information of a resource for carrying the data.

Except for a case where resource allocation information for the data changes, such as a case where a location of a resource or a transmission period of data changes, the persistent resource allocation information is transmitted one time before transmitting the data, and is transmitted in such a manner that the information can be received by all SSs belonging to the M2M communication service group, that is, the information is multicast. For example, in a case of a system that performs Cyclic Redundancy Check (CRC) coding or scrambling on the resource allocation information into a unique sequence allocated to a receiving SS, a sequence shared by the SS belonging to the group is used as the persistent resource allocation information. In other words, when the persistent resource allocation information is multicast to a plurality of SSs belonging to the M2M communication service group, the persistent resource allocation information is encoded into an ID of the service group. The persistent resource allocation information may be configured by Table 1 below.

TABLE 1

| | | Size | |
|---|---|---|---|
| Syntax | | (bits) | Description/Notes |
| Multicast Persistent | | | |
| Allocation MAP IE( ) { | | | |
| MAP IE type | | 4 | Multicast Persistent Allocation MAP IE |
| Allocation Period | | | Period of persistent allocation. If this field is |
| | | | set to 0b00, it indicates the de-allocation of |
| | | | a persistently allocated resource. |
| | | | 0b00: de-allocation |
| | | | 0b01: 16 superframes |
| | | | . . . |
| If(Allocation Period == | | | |
| 0b00) { | | | |
| | Resource Index | 11 | Confirmation of the resource index for a |
| | | | previously assigned persistent resource that |
| | | | has been de-allocated. |
| | | | 5 MHz: 0 in first 2 MSB bits + 9 bits for |
| | | | resource index |
| | | | 10 MHz: 11 bits for resource index |
| | | | 20 MHz: 11 bits for resource index |
| | | | Resource index includes location and |
| | | | allocation size |
| } | | | |
| Else { | | | |
| | ISizeOffset | 5 | Offset used to compute burst size index |
| | Multiple-Input Multiple | 1 | 0b0: Spatial-Frequency-Block-Coding |
| Output (MIMO) mode | | | (SFBC) |
| | | | 0b1: Vertical encoding |
| | If(MIMO mode == 0b1) { | | |
| | Number of streams (Mt) | 3 | Number of streams in transmission Mt <= |
| | | | Nt |
| | | | Nt: number of transmit antennas at the BS |
| | | | 0b000: 1 stream |
| | | | 0b001: 2 streams |
| | | | 0b010: 3 streams |
| | | | 0b011: 4 streams |
| | | | 0b100: 5 streams |
| | | | 0b101: 6 streams |
| | | | 0b110: 7 streams |
| | | | 0b111: 8 streams |
| | } | | |
| | Resource Index | 11 | 5 MHz: 0 in first 2 Most Significant Bits |
| | | | (MSB) bits + 9 bits for resource index |
| | | | 10 MHz: 11 bits for resource index |
| | | | 20 MHz: 11 bits for resource index |
| | | | Resource index includes location and |
| | | | allocation size |
| | Long TTI indicator | 1 | Indicates number of subframes spanned by |

| | |
|---|---|
| | the allocated resource |
| | 0b0: 1 subframe |
| | 0b1: all DownLink (DL) subframes |
| } | |
| } | |

The persistent resource allocation information is used to release a pre-allocated persistent resource or to allocate a new persistent resource. In addition, as illustrated in Table 1 above, when the new persistent resource is allocated, the persistent resource allocation information includes period information according to which the persistent resource is allocated, and includes information of the allocated persistent resource and information on a MIMO mode applied to data transmitted by using the persistent resource.

Table 1 above shows persistent resource allocation information under the assumption that a system encodes resource allocation information into a unique sequence allocated to the receiving SS. Accordingly, the persistent resource allocation information of Table 1 above does not include information for announcing a group. According to another exemplary embodiment of the present invention, the resource allocation information may include information on a recipient. In this case, the persistent resource allocation information further includes information that indicates a group, that is, group ID, in addition to elements illustrated in Table 1 above. The M2M SS 200 may determine whether the persistent resource allocation information is successfully received according to whether a group ID of a group to which the M2M SS 200 belongs is included in the persistent resource allocation information.

Upon receiving the persistent resource allocation information, the M2M SS 200 transmits to the M2M BS 250 a feedback signal for announcing successful reception of the persistent resource allocation information in step 205. For example, the feedback signal may be an HARQ ACKnowledgement (ACK). In this case, resource allocation information for transmitting the feedback signal for the persistent resource allocation information is included in the persistent resource allocation information transmitted in step 203. For convenience of explanation, the ‘feedback signal for the persistent resource allocation information’ is hereinafter referred to as a ‘feedback resource’.

For example, the persistent resource allocation information of Table 1 above may include feedback resource allocation information of Table 2 below.

TABLE 2

| | | |
|---|---|---|
| | Size | |
| Syntax | (bits) | Description/Notes |

HARQ Channel Info( ) {

| Start Index | — | The start index of resource unit |
|---|---|---|
| | | (e.g. DL Resource Units (DLRUs) |
| | | index) for HARQ channel |
| Number of units | — | The number of units (e.g., DLRUs) |
| | | for HARQ channel |
| HARQ channel | — | The number of HARQ channels |
| number | | Describes LHFB |

| | |
|---|---|
| | Different number of HARQ channels |
| | can be used based on bandwidth |
| } | |

As illustrated in Table 2 above, the feedback resource allocation information includes a start point of an HARQ channel, a size of the HARQ channel, and the number of HARQ channels. In an HARQ channel area allocated according to Table 2 above, a location of the HARQ channel allocated to the M2M SS 200 is identified by an index included in service group information transmitted in step 201. HARQ channels of SSs are located sequentially in the HARQ channel area according to an order of the index. The M2M SS 200 transmits the feedback signal through the HARQ channel indicated by an index of the M2M SS 200.

Thereafter, the M2M BS 250 transmits multicast data for a group to SSs belonging to the M2M communication service group by using a resource indicated by the persistent resource allocation information in step 207-1. For convenience of explanation, the ‘multicast group for the group’ is hereinafter referred to as ‘group data’. Assuming that the group data is multicast data transmitted to all SSs of the M2M communication service group with a time period T, the M2M BS 250 transmits the group data by using a resource indicated by the persistent resource allocation information in every time period T in step 207-2 to step 207-3.

In FIG. 2, the M2M BS 250 transmits the persistent resource allocation information in a format that can be received by all SS in the group. However, if the persistent resource allocation information is transmitted at least one time before the M2M SS 200 is registered to the M2M communication service group, the persistent resource allocation information is not necessarily received by all SS in the group. In this case, the M2M BS 250 may provide the persistent resource allocation information to the M2M SS 200 in a unicast fashion. If the persistent resource allocation information is multicast, the persistent resource allocation information is encoded into an ID of a service group, and if the persistent resource allocation information is unicast to a specific SS, the persistent resource allocation information is encoded into an ID of the specific SS.

In addition, according to another exemplary embodiment of the present invention, if the persistent resource allocation information is transmitted at least one time before the M2M SS 200 is registered to the M2M communication service group, the M2M BS 250 multicasts the persistent resource allocation information in a format that can be received by a plurality of SSs, and may include information for announcing retransmission. Accordingly, other SSs which have already received the persistent resource allocation information may ignore the retransmitted persistent resource allocation information. For example, the information for announcing whether the persistent resource allocation information is retransmitted can be configured by Table 3 below.

TABLE 3

| | Size | |
|---|---|---|
| Syntax | (bits) | Description/Notes |
| Initial transmission | 1 | This field indicates whether Multicast |
| indicator | | Persistent Allocation (PA) MAP IE is |
| | | initial transmission or not |
| | | 0: initial transmission of Multicast PA |
| | | MAP IE |
| | | 1: retransmission of Multicast PA MAP |
| | | IE |

If an initial transmission indicator of Table 3 above is included, the SS can know whether the received persistent resource allocation information is initially transmitted information or retransmitted information. When receiving the initially received persistent resource allocation information, the SS stores the initially transmitted persistent resource allocation information as latest information. When the retransmitted persistent resource allocation information, an SS which has previously received the initially transmitted persistent resource allocation information ignores the retransmitted persistent resource allocation information, and an SS which has not previously received the persistent resource allocation information stores the retransmitted persistent resource allocation information as latest information. The SS which has previously received the initially transmitted persistent resource allocation information does not have to decode the retransmitted persistent resource allocation information, and thus unnecessary power consumption and computations can be omitted.

In FIG. 2, the SS transmits the feedback signal through the HARQ channel for the persistent resource allocation information provided by the BS. This is to recognize a reception failure in the BS, since if the persistent resource allocation information is not received, group data periodically transmitted afterwards cannot be received at all. However, according to another exemplary embodiment of the present invention, the SS may transmit a feedback message for the group data. In this case, the SS does not transmit the feedback signal according to reception of the persistent resource allocation information, and transmits feedback data according to reception of group data periodically transmitted afterwards. Accordingly, if there is an SS which does not transmit the feedback data, the BS retransmits the persistent resource allocation information.

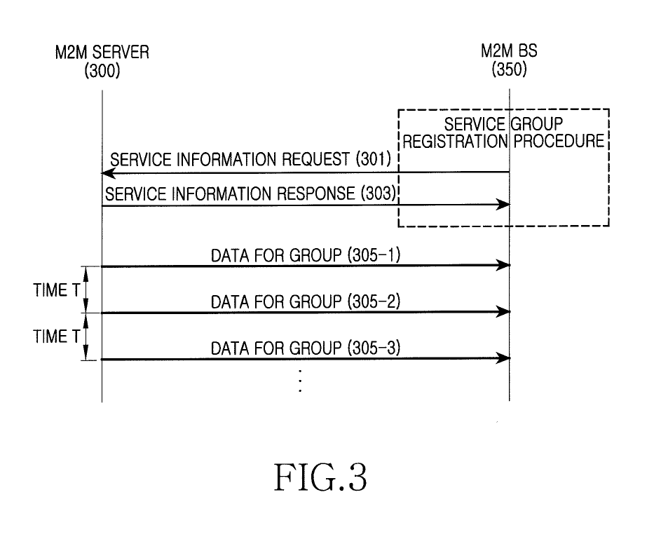

FIG. 3 illustrates a process of exchanging a signal between a server and a BS which transmit and receive group data in an M2M communication system according to an exemplary embodiment of the present invention.

Referring to FIG. 3, while performing a service group registration procedure with respect to an SS, an M2M BS 350 transmits to an M2M server 300 a service information request message including information of the SS via a higher-layer system in step 301. Examples of the higher-layer system include an ASN-GW, a CSN, etc.

Upon receiving the service information request message, the M2M server 300 provides M2M communication service group information for indicating a service group to which the SS intends to be registered to the M2M BS 350 via the higher-layer system in step 303. The M2M communication service group information may include whether the group has group data to be periodically transmitted, a size of the group data, a transmission period of the group data, etc. A group ID is managed by the M2M server 300 or is managed by the M2M BS 350. When the group ID is managed by the M2M server 300, the M2M communication service group information delivered from the M2M server 300 to the M2M BS 350 includes the group ID.

The M2M server 300 delivers the group data to the M2M BS 350 according to the information provided in step 303, that is, according to the transmission period of the group data, and requests multicasting of the group data in step 305-1 to step 305-3.

An operation and structure of a BS and an SS which periodically transmit and receive group data is described below.

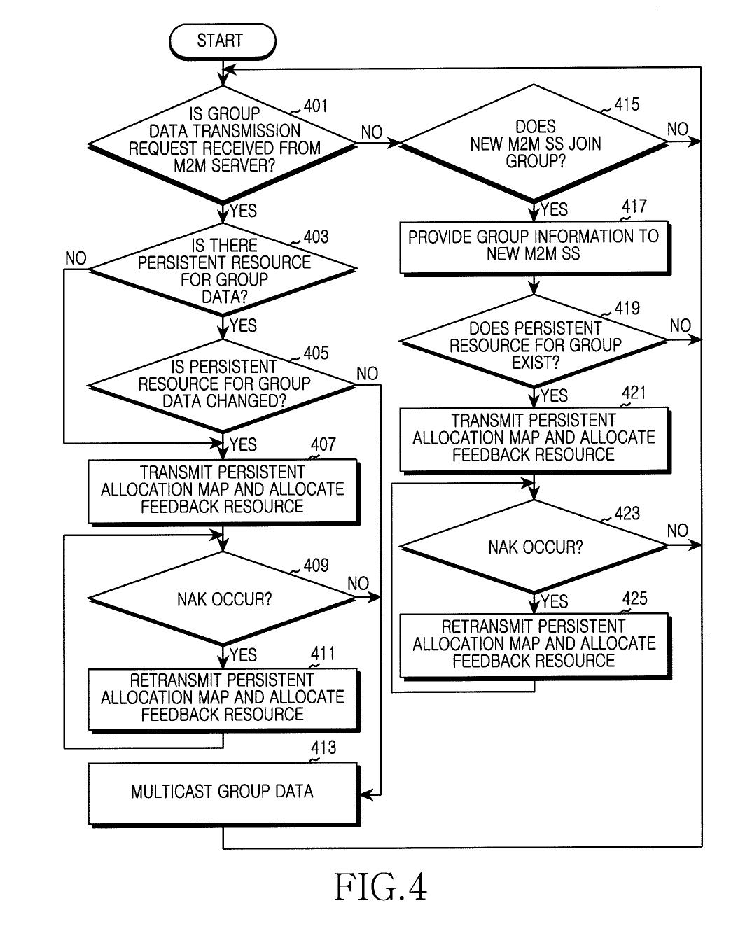

FIG. 4 is a flowchart illustrating an operation of a BS in an M2M communication system according to a first exemplary embodiment of the present invention. In FIG. 4, the process of operating the BS is based on an exemplary embodiment for a case where a feedback signal for persistent resource allocation information is transmitted through a feedback channel.

Referring to FIG. 4, the BS determines whether a group data transmission request is received from a server in step 401. The group data transmission request includes an operation in which the BS receives information on a size of group data and a transmission period of the group data from the service via a higher layer system as described in FIG. 3 and then receives the group data.

Upon receiving the group data transmission request, the BS determines in step 403 whether a persistent resource for transmitting the group data is allocated. The BS determines whether a resource for the group data is persistently allocated and whether persistent resource allocation information for indicating the resource for transmission of the group data has previously transmitted to SSs of a specific group. If there is no persistent resource for the group data, the BS proceeds to step 407.

If the persistent resource for the group data exists, the BS determines in step 405 whether the persistent resource for the group data is changed or needs to be changed. For example, the change in the persistent resource may include at least one of an increase/decrease of an allocation period of the persistent resource, a positional movement of the persistent resource, and an increase/decrease of a size of the persistent resource. The positional movement of the persistent resource may occur according to resource management of the BS. The increase/decrease of the persistent resource may occur according to a change in an amount of the group data or a change in a modulation scheme or coding scheme applied to the group data. If the change in the persistent resource is not necessary, the BS proceeds to step 413.

If the persistent resource needs to be changed, or if the persistent resource does not exist in step 403, the BS configures the persistent resource for the group data, and transmits the persistent resource allocation information, e.g., persistent allocation MAP, in step 407. For example, the persistent allocation MAP may be configured as illustrated in Table 1 above. In this case, the BS also transmits resource allocation information for transmitting a feedback signal for the persistent allocation MAP. The feedback resource allocation information may be configured as illustrated in Table 2 above. Table 1 above is an exemplary persistent allocation MAP under the assumption that a system encodes the resource allocation information into a unique sequent allocated to a receiving SS. According to another exemplary embodiment of the present invention, a system which includes information for a recipient in the resource allocation information further includes information for indicating a group, that is, a group ID.

In step 409, the BS determines whether a Non ACK (NAK) occurs. The generation of the NAK indicates a case where a feedback signal that explicitly indicates a reception failure is received or a case where a feedback signal that indicates a reception success is not received from at least one SS. The BS determines whether an SS has failed to receive the persistent allocation MAP. If the NAK is not generated, the BS proceeds to step 413.

If the NAK occurs, the BS retransmits the persistent allocation MAP for the SS which failed to receive the persistent allocation MAP, and allocates a feedback resource for the SS in step 411. Retransmission of the persistent allocation MAP may be either unicast transmission to the SS or multicast transmission as transmission including information for announcing retransmission. For example, in case of unicast, the BS encodes the persistent allocation MAP into an ID of the SS. In case of multicast, the BS encodes the persistent allocation MAP including the information for announcing retransmission into an ID shared by SSs in a group, for example, a group ID. The encoding includes at least one of scrambling and CRC coding. Returning to step 409, the BS determines whether a NAK occurs.

If the NAK is not generated in step 409 or if the persistent resource does not need to be changed in step 405, the BS multicasts the group data received from the server in step 413 by using a resource indicated by the persistent allocation MAP.

If the group data transmission request is not received in step 401, the BS determines in step 415 whether a new M2M SS joins the service group. The BS determines whether the new SS starts a service group registration procedure. For example, the service group registration procedure may be performed by inserting information for indicating service group registration into a message transmitted in a network entry procedure or a service flow creation procedure.

If the new SS joins the group, the BS provides service group information to the new SS in step 417. The BS requests the server to send the service group information, receives the service group information from the server, and then provides the service group information to the new SS. The service group information provided from the server may include whether there is group data to be periodically transmitted to the group, a size of the group data, a transmission period of the group data, etc. In addition, the service group information provided to the SS may include a service group ID and an index allocated to the SS.

In step 419, the BS determines whether persistent allocation is provided for the service group. The BS determines whether there is the group data periodically transmitted from the service group, and if the group data exists, whether a resource for the group data is persistently allocated. If the persistent allocation is not provided for the service group, the BS returns to step 401.

If the persistent allocation is provided for the service group, the BS transmits persistent resource information, i.e., a persistent allocation MAP, to the new SS and allocates a feedback resource for the SS in step 421. The persistent allocation MAP is transmitted in the same manner as when it is retransmitted according to NAK generation after multicasting. Transmission of the persistent allocation MAP may be either unicast transmission to the new SS or multicast transmission as transmission including information for announcing retransmission. In the case of unicast, the BS encodes the persistent allocation MAP into an ID of the new SS. In the case of multicast, the BS encodes the persistent allocation MAP including the information for announcing retransmission into an ID shared by SSs in a group, for example, a group ID. The encoding includes at least one of scrambling and CRC coding.

In step 423, the BS determines whether a NAK occurs. The generation of the NAK indicates a case where a feedback signal that explicitly indicates a reception failure is received or a case where a feedback signal that indicates a reception success is not received from the new SS. The BS determines whether the new SS has failed to receive the persistent allocation MAP. If the NAK is not generated, the BS returns to step 401.

If the NAK occurs, the BS retransmits the persistent allocation MAP for the new SS, and allocates a feedback resource for the SS in step 425. Retransmission of the persistent allocation MAP may be either unicast transmission to the new SS or multicast transmission as transmission including information for announcing retransmission. In case of unicast, the BS encodes the persistent allocation MAP into an ID of the new SS. In the case of multicast, the BS encodes the persistent allocation MAP including the information for announcing retransmission into an ID shared by SSs in a group, for example, a group ID. Herein, the encoding includes at least one of scrambling and CRC coding.

In FIG. 4, it is assumed that the group data is downlink data. However, the group data may be uplink data to be provided from the M2M SS to the M2M server. In this case, the persistent allocation MAP includes information on persistent allocation of an uplink resource, and step 413 is replaced with an operation for receiving the group data.

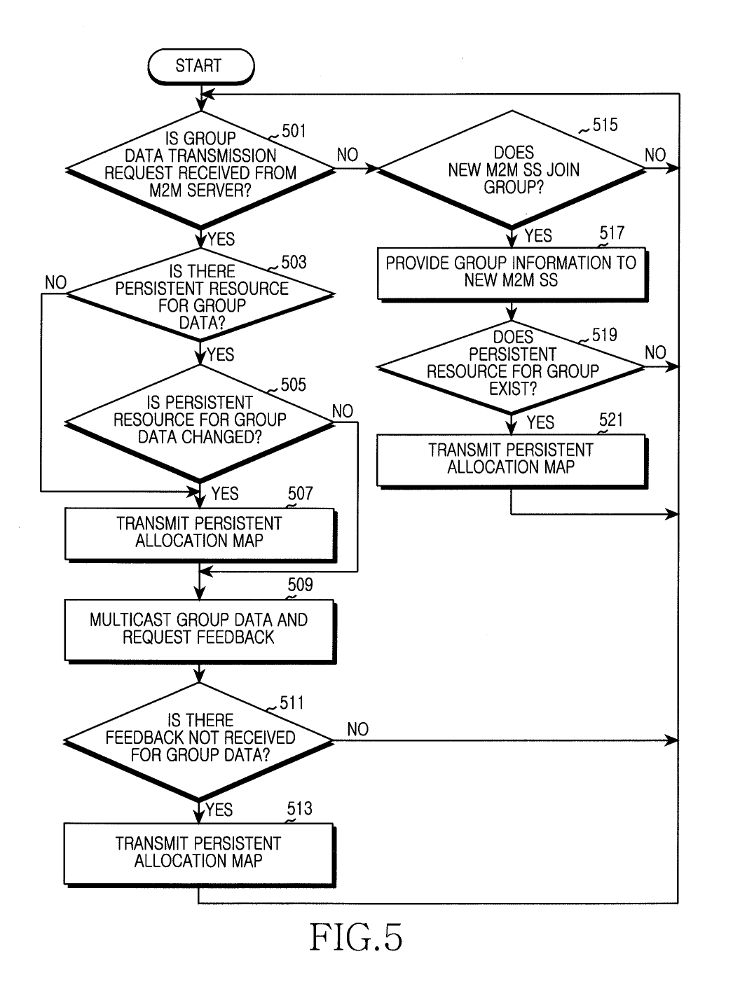

FIG. 5 is a flowchart illustrating a process of operating a BS in an M2M communication system according to a second exemplary embodiment of the present invention. In FIG. 5, the process of operating the BS is based on an exemplary embodiment for a case where feedback data is transmitted for group data.

Referring to FIG. 5, the BS determines whether a group data transmission request is received from a server in step 501. The group data transmission request includes an operation in which the BS receives information on a size of group data and a transmission period of the group data from the service via a higher layer system as described in FIG. 3 and then receives the group data.

Upon receiving the group data transmission request, the BS determines in step 503 whether a persistent resource for transmitting the group data is allocated. The BS determines whether a resource for the group data is persistently allocated and whether persistent resource allocation information for indicating the resource for transmission of the group data has previously transmitted to SSs of a specific group. If there is no persistent resource for the group data, the BS proceeds to step 507.

If the persistent resource for the group data exists, the BS determines in step 505 whether the persistent resource for the group data is changed or needs to be changed. For example, the change in the persistent resource may include at least one of an increase/decrease of an allocation period of the persistent resource, a positional movement of the persistent resource, and an increase/decrease of a size of the persistent resource. The positional movement of the persistent resource may occur according to resource management of the BS. The increase/decrease of the persistent resource may occur according to a change in an amount of the group data or a change in a modulation scheme or coding scheme applied to the group data. If a change in the persistent resource is not necessary, the BS proceeds to step 509.

If the persistent resource needs to be changed, or if the persistent resource does not exist in step 503, the BS configures the persistent resource for the group data, and transmits the persistent resource allocation information, e.g., persistent allocation MAP, in step 507. The persistent allocation MAP may be configured as illustrated in Table 1 above. Table 1 above is an exemplary persistent allocation MAP under the assumption that a system encodes the resource allocation information into a unique sequent allocated to a receiving SS. According to another exemplary embodiment of the present invention, a system which includes information for a recipient in the resource allocation information further includes information for indicating a group, that is, a group ID.

In step 509, the BS multicasts the group data received from the server by using a resource indicated by the persistent allocation MAP. In this case, the BS requests a feedback for the group data. However, when the feedback for the group data is performed according to a protocol pre-defined between the BS and SS, the feedback request can be omitted.

In step 511, the BS determines whether feedback data for the group data is received from all SSs belonging to the service group. The BS determines whether there is a feedback not received from at least one SS. The feedback data may be a bit-stream which does not include contents and indicates a reception success or may be data having information corresponding to the group data. If all feedback has been received, the BS returns to step 501.

If the BS has not received feedback from all of the SSs, the BS determines in step 513 that SSs which have not transmitted the feedback data has failed to receive the persistent allocation MAP, and retransmits the persistent allocation MAP for the SS.

Retransmission of the persistent allocation MAP may be either unicast transmission to the SS or multicast transmission as transmission including information for announcing retransmission. For example, in case of unicast, the BS encodes the persistent allocation MAP into an ID of the SS. In case of multicast, the BS encodes the persistent allocation MAP including the information for announcing retransmission into an ID shared by SSs in a group, for example, a group ID. The encoding includes at least one of scrambling and CRC coding. The BS then returns to step 501.

If the group data transmission request is not received in step 501, the BS determines in step 515 whether a new M2M SS joins the service group. The BS determines whether the new SS starts a service group registration procedure. For example, the service group registration procedure may be performed by inserting information for indicating service group registration into a message transmitted in a network entry procedure or a service flow creation procedure.

If the new SS joins the group, the BS provides service group information to the new SS in step 517. The BS requests the server to send the service group information, receives the service group information from the server, and then provides the service group information to the new SS. The service group information provided from the server may include whether there is group data to be periodically transmitted to the group, a size of the group data, a transmission period of the group data, etc. In addition, the service group information provided to the SS may include a service group ID and an index allocated to the SS.

In step 519, the BS determines whether persistent allocation is provided for the service group. The BS determines whether there is the group data periodically transmitted from the service group, and if the group data exists, whether a resource for the group data is persistently allocated. If the persistent allocation is not provided for the service group, the BS returns to step 501.

If the persistent allocation is provided for the service group, the BS transmits persistent resource information, i.e., a persistent allocation MAP, to the new SS in step 521. The persistent allocation MAP is transmitted in the same manner as when it is transmitted for a specific SS in step 513. Transmission of the persistent allocation MAP may be either unicast transmission to the new SS or multicast transmission as transmission including information for announcing retransmission. In the case of unicast, the BS encodes the persistent allocation MAP into an ID of the new SS. In the case of multicast, the BS encodes the persistent allocation MAP including the information for announcing retransmission into an ID shared by SSs in a group, for example, a group ID. The encoding includes at least one of scrambling and CRC coding. Thereafter, the BS returns to step 501.

In the exemplary embodiment described with reference to FIG. 5, it is assumed that the group data is downlink data. However, the group data may be uplink data to be provided from the M2M SS to the M2M server. In this case, the persistent allocation MAP includes information on persistent allocation of an uplink resource, and step 509 is replaced with an operation for receiving the group data. In addition, since the group data is uplink data, the feedback data for determining whether the persistent allocation MAP is received is not necessary, and the group data substitutes for a function of the feedback data.

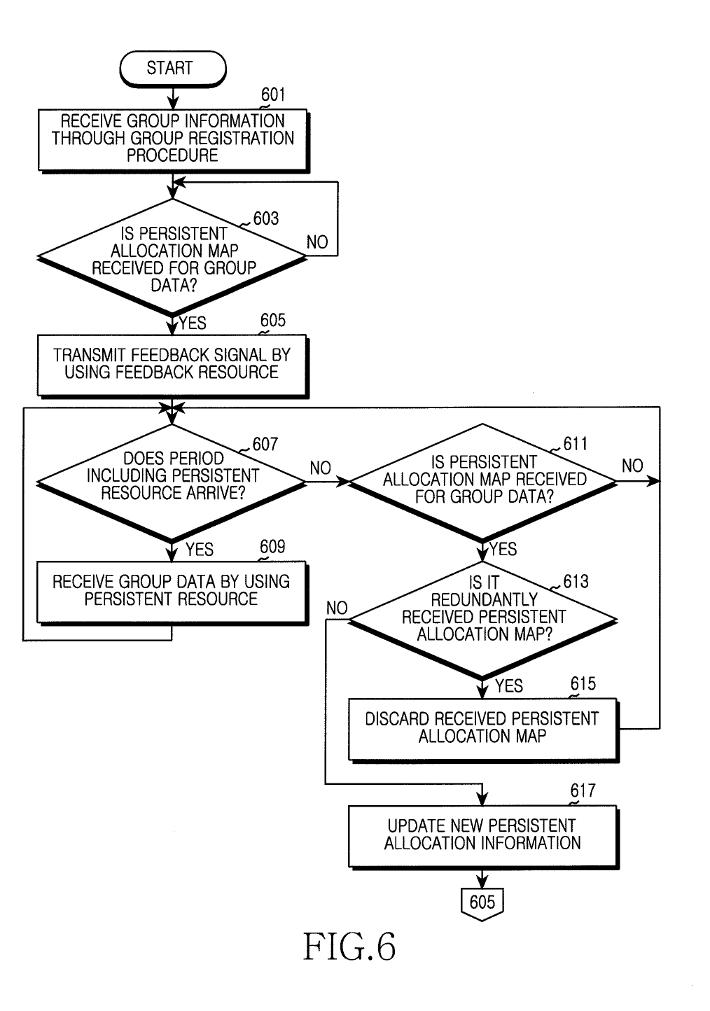

FIG. 6 is a flowchart illustrating a process of operating an SS in an M2M communication system according to a first exemplary embodiment of the present invention. In FIG. 6, the process of operating the SS is based on an exemplary embodiment for a case where a feedback signal for persistent resource allocation information is transmitted through a feedback channel.

Referring to FIG. 6, the SS receives service group information by using an M2M communication service group registration procedure in step 601. Herein, the service group information includes an ID of the group and information on an index allocated to the SS in the group. For example, the service group registration procedure is performed by inserting information for indicating service group registration into a message transmitted in a network entry procedure or a service flow creation procedure.

In step 603, the SS determines whether persistent resource allocation information for group data of the service group, e.g., a persistent allocation MAP, is received. The persistent allocation MAP includes at least one of location information of a persistent resource, size information, period information, and MIMO mode information and includes allocation information of a resource for transmitting a feedback signal for the persistent allocation MAP. The persistent allocation MAP may be configured as illustrated in Table 1 above. In addition, the persistent allocation MAP may further include information that indicates whether current transmission is retransmission. If unicast transmission is used in retransmission, the information for indicating whether current transmission is retransmission may be omitted. Table 1 above is an exemplary persistent allocation MAP under the assumption that a system encodes the resource allocation information into a unique sequent allocated to a receiving SS. According to another exemplary embodiment of the present invention, a system which includes information for a recipient in the resource allocation information further includes information for indicating a group, that is, a group ID.

Upon receiving the persistent allocation MAP, the SS stores allocation information for the persistent resource included in the persistent allocation MAP, and transmits a feedback signal by using feedback information indicated by feedback resource allocation information included in the persistent allocation MAP in step 605. The feedback resource allocation information includes at least one of start point information, size information, and count information of the feedback channel. The feedback resource allocation information may be configured as illustrated in Table 2 above. The feedback channel allocated to the SS is identified by an index included in the service group information.

In step 607, the SS determines whether a period including the persistent resource arrives. The period indicates a unit of performing resource allocation, and may be a frame for example. The SS determines whether a frame including the persistent resource arrives.

Upon arrival of the period including the persistent resource, the SS receives group data in step 609 by using the persistent resource. The SS acquires the group data by demodulating and decoding a signal received by using the persistent resource. Thereafter, the SS returns to step 607.

If the period including the persistent resource does not arrive in step 607, the SS determines in step 611 whether the persistent allocation MAP for the group data is received.

Upon receiving the persistent allocation MAP, the SS determines in step 613 whether the persistent allocation MAP is a redundantly received persistent allocation MAP. The persistent allocation MAP includes information indicating whether current transmission is retransmission, and the SS can determine whether the persistent allocation MAP has already been received by using the information that indicates whether current transmission is retransmission. If the information indicating whether current transmission is retransmission is set to a value that indicates retransmission, the SS recognizes the persistent allocation MAP as the redundantly received persistent allocation MAP.

If the persistent allocation MAP is the redundantly received persistent allocation MAP, the SS discards the redundantly received persistent allocation MAP in step 615. The SS maintains the pre-stored persistent allocation information and ignores the persistent allocation information included in the redundantly received persistent allocation MAP.

If the persistent allocation MAP is not the redundantly received persistent allocation MAP, the SS updates the pre-stored persistent allocation information to new persistent allocation information included in the persistent allocation MAP in step 617. Thereafter, returning to step 605, the SS transmits a feedback signal.

Steps 611 to step 617 are performed when retransmission of the persistent allocation MAP is multicast transmission and includes information that indicates whether current transmission is retransmission. If retransmission of the persistent allocation MAP is unicast transmission to a specific SS, step 611 to step 617 can be omitted.

In addition, in step 613, the SS determines whether the persistent allocation MAP has already been received by using the information that indicates whether current transmission is retransmission. According to another exemplary embodiment of the present invention, the SS can compare contents of the persistent allocation MAP with contents of the previously received persistent allocation MAP in addition to the information indicating whether current transmission is retransmission and thus can determine whether the persistent allocation MAP has already been received. According to another exemplary embodiment of the present invention, irrespective of the information that indicates whether current transmission is retransmission, the SS can compare the contents of the persistent allocation MAP with the contents of the previously received persistent allocation MAP to determine whether the persistent allocation MAP has already been received.

Although not shown in FIG. 6, if the persistent allocation MAP received in step 603 or step 611 indicates release of the persistent resource, the SS deletes the pre-stored persistent allocation information and releases the persistent resource. The persistent allocation MAP may be used not only for new allocation and change of the persistent resource but also for release of the persistent resource.

In the exemplary embodiment described with reference to FIG. 6, it is assumed that the group data is downlink data. However, the group data may be uplink data to be provided from the M2M SS to the M2M server. In this case, the persistent allocation MAP includes information on persistent allocation of an uplink resource, and step 609 is replaced with an operation for transmitting the group data.

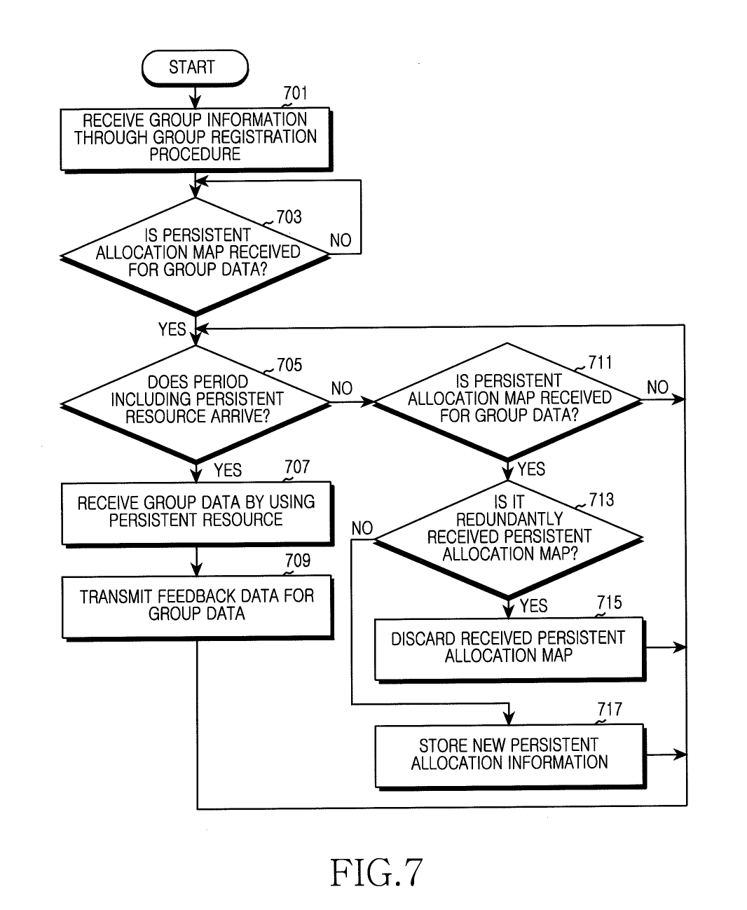

FIG. 7 is a flowchart illustrating a process of operating an SS in an M2M communication system according to a second exemplary embodiment of the present invention. In FIG. 7, the process of operating the SS is based on an exemplary embodiment for a case where feedback data is transmitted for group data.

Referring to FIG. 7, the SS receives service group information according to an M2M communication service group registration procedure in step 701. The service group information includes an ID of the group and information on an index allocated to the SS in the group. For example, the service group registration procedure may be performed by inserting information for indicating service group registration into a message transmitted in a network entry procedure or a service flow creation procedure.

In step 703, the SS determines whether persistent resource allocation information for group data of the service group, that is, a persistent allocation MAP, is received. The persistent allocation MAP includes at least one of location information of a persistent resource, size information, period information, and MIMO mode information, and includes allocation information of a resource for transmitting a feedback signal for the persistent allocation MAP. The persistent allocation MAP may be configured as illustrated in Table 1 above. In addition, the persistent allocation MAP may further include information that indicates whether current transmission is retransmission. If unicast transmission is used in retransmission, the information for indicating whether current transmission is retransmission may be omitted. Table 1 above is an exemplary persistent allocation MAP under the assumption that a system encodes the resource allocation information into a unique sequent allocated to a receiving SS. According to another exemplary embodiment of the present invention, a system which includes information for a recipient in the resource allocation information further includes information for indicating a group, that is, a group ID.

Upon receiving the persistent allocation MAP, the SS determines in step 705 whether a period including the persistent resource arrives. The period indicates a unit of performing resource allocation, and may be a frame for example. The SS determines whether a frame including the persistent resource arrives.

Upon arrival of the period including the persistent resource, the SS receives group data in step 707 by using the persistent resource. The SS acquires the group data by demodulating and decoding a signal received by using the persistent resource.

In step 709, the SS transmits feedback data for the group data. The feedback data may be a bit-stream which does not include contents and indicates a reception success or may be data having information corresponding to the group data. Transmission of the feedback data may be performed according to a protocol pre-defined between the BS and SSs. Alternatively, according to another exemplary embodiment of the present invention, transmission of the feedback data may be performed according to a feedback request received together with group data in step 707. Thereafter, SS returns to step 705.

If the period including the persistent resource does not arrive in step 705, the SS determines in step 711 whether the persistent allocation MAP for the group data is received.

Upon receiving the persistent allocation MAP, the SS determines in step 713 whether the persistent allocation MAP is a redundantly received persistent allocation MAP. The persistent allocation MAP includes information for indicating whether current transmission is retransmission, and the SS can determine whether the persistent allocation MAP has already been received by using the information that indicates whether current transmission is retransmission. If the information indicating whether current transmission is retransmission is set to a value that indicates retransmission, the SS recognizes the persistent allocation MAP as the redundantly received persistent allocation MAP.

If the persistent allocation MAP is the redundantly received persistent allocation MAP, the SS discards the redundantly received persistent allocation MAP in step 715. The SS maintains the pre-stored persistent allocation information and ignores the persistent allocation information included in the redundantly received persistent allocation MAP.

If the persistent allocation MAP is not the redundantly received persistent allocation MAP, proceeding to step 717, the SS updates the pre-stored persistent allocation information to new persistent allocation information included in the persistent allocation MAP. The SS transmits a feedback signal in step 705.

Steps 711 to step 717 are performed when retransmission of the persistent allocation MAP is multicast transmission and includes information that indicates whether current transmission is retransmission. If retransmission of the persistent allocation MAP is unicast transmission to a specific SS, step 711 to step 717 can be omitted. In addition, the SS may determine whether the persistent allocation MAP has already been received in step 713 according to the various methods described above with respect to FIG. 6.

Although not shown in FIG. 7, if the persistent allocation MAP received in step 703 or step 711 indicates release of the persistent resource, the SS deletes the pre-stored persistent allocation information and releases the persistent resource. The persistent allocation MAP may be used not only for new allocation and change of the persistent resource but also release of the persistent resource.

In the exemplary embodiment described with reference to FIG. 7, it is assumed that the group data is downlink data. However, the group data may be uplink data to be provided from the M2M SS to the M2M server. In this case, the persistent allocation MAP includes information on persistent allocation of an uplink resource, and step 709 is replaced with an operation for receiving the group data. In addition, since the group data is uplink data, the feedback data for determining whether the persistent allocation MAP is received is not necessary, and thus step 709 may be omitted.

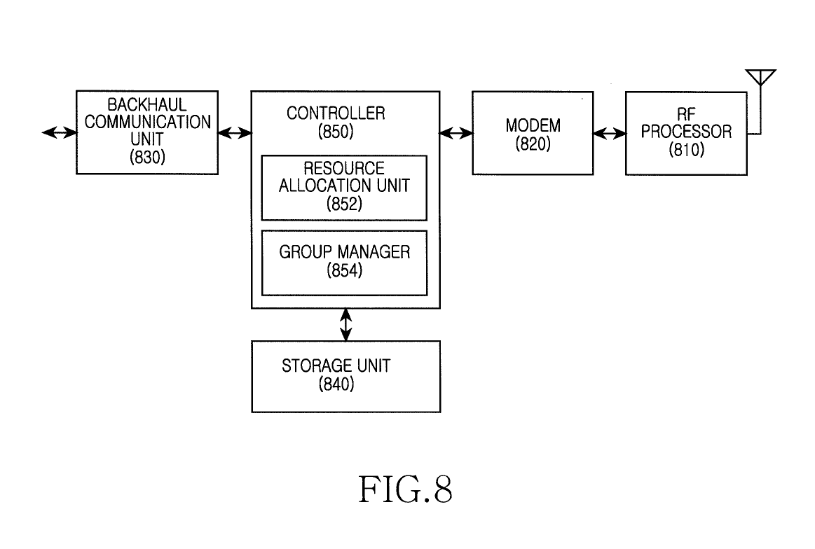

FIG. 8 is a block diagram of a BS in an M2M communication system according to an exemplary embodiment of the present invention.

Referring to FIG. 8, the BS includes a Radio Frequency (RF) processor 810, a modem 820, a backhaul communication unit 830, a storage unit 840, and a controller 850.

The RF processor 810 performs functions related to transmitting and receiving a signal through a radio channel, such as signal band conversion, amplification, or the like. The RF processor 810 up-converts a baseband signal provided from the modem 820 into an RF band signal and then transmits the RF band signal through an antenna, and down-converts the RF band signal received through the antenna into a baseband signal.

The modem 820 converts the baseband signal to/from a bit-stream according to a physical layer protocol of the system. For example, in data transmission, the modem 820 generates complex symbols by performing coding and modulation on a Transmit (Tx) bit-stream, maps the complex symbols to subcarriers, and configures OFDM symbols by performing an Inverse Fast Fourier Transform (IFFT) operation and inserting a Cyclic Prefix (CP). In data reception, the modem 820 divides the baseband signal provided from the RF processor 810 in an OFDM symbol unit, restores signals mapped to subcarriers by performing a Fast Fourier Transform (FFT) operation, and then restores a Receive (Rx) bit-stream by performing demodulation and decoding.

The backhaul communication unit 830 provides an interface for performing communication with a higher-layer system. The backhaul communication unit 830 converts a bit-stream transmitted from the BS to a higher-layer system (e.g., an ASN-GW) into a physical signal, and converts a physical signal received from the ASN-GW into a bit-stream. The storage unit 840 stores a basic program for operating the BS, an application program, and data such as user content. The storage unit 840 provides the stored data at the request of the controller 850. The storage unit 840 temporarily stores group data received from an M2M server, and stores group registration information of M2M SSs.

The controller 850 provides overall control to the BS. For example, the controller 850 configures downlink data and provides the data to the modem 820, and interprets uplink data provided from the modem 820. The controller 850 includes a resource allocation unit 852 for allocating resources to accessed SSs and a group manager 854 for managing group registration information of the M2M SSs. The controller 850 controls a function for multicasting periodically generated group data to M2M SSs registered to a corresponding group as follows.

Upon receiving a group data transmission request from the M2M server via the backhaul communication unit 830, the controller 850 determines whether a persistent resource for transmitting the group data is allocated. If the persistent resource does not exist, or if it exists but the persistent resource needs to be changed, the controller 850 configures the persistent resource for the group data and transmits the persistent resource allocation information, e.g., a persistent allocation MAP. Thereafter, the controller 850 multicasts the group data via the modem 820 and the RF processor 810.

When a new SS joins the group, the controller 850 provides service group information to the new SS. The service group information provided to the new SS may include a service group ID and an index allocated to the SS. If the persistent allocation is provided for the service group, the controller 850 transmits the persistent allocation MAP to the new SS, and allocates a feedback resource for the SS. The persistent allocation MAP is transmitted in the same manner as when it is retransmitted according to NAK generation after multicasting. Thereafter, the controller 850 determines whether the new SS successfully receives the persistent allocation MAP, and if a NAK occurs, retransmits the persistent allocation MAP.

In the aforementioned persistent allocation MAP transmission method, in order to determine whether the persistent allocation MAP is successfully received, the controller 850 operates as follows. According to a first exemplary embodiment of the present invention, the controller 850 transmits the persistent allocation MAP, and thereafter determines whether a NAK occurs for the persistent allocation MAP. Whether the NAK occurs can be determined according to whether a feedback signal is received depending on successful reception of the persistent allocation MAP. If the NAK occurs for the persistent allocation MAP, the controller 850 retransmits the persistent allocation MAP for an SS which fails to receive the persistent allocation MAP, and allocates a feedback resource for the SS.

According to a second exemplary embodiment of the present invention, the controller 850 may use feedback data for the group data to determine whether the persistent allocation MAP is successfully received instead of whether the NAK occurs for the persistent allocation MAP. In this case, the controller 850 multicasts the group data, and thereafter determines whether feedback data is received from all M2M SSs registered to the service group, and if the feedback data is not received from at least one M2M SS, retransmits the persistent allocation MAP. In the first and second exemplary embodiments of the present invention, retransmission of the persistent allocation MAP may be either unicast transmission to the SS or multicast transmission as transmission including information for announcing retransmission.

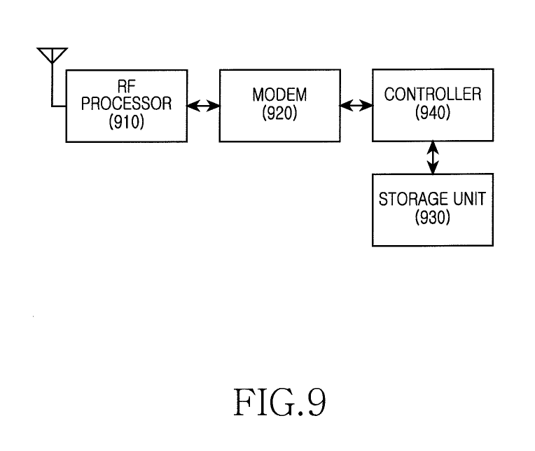

FIG. 9 is a block diagram of an SS in an M2M communication system according to an exemplary embodiment of the present invention.

Referring to FIG. 9, a BS includes an RF processor 910, a modem 920, a storage unit 930, and a controller 940.

The RF processor 910 performs functions related to transmitting and receiving a signal through a radio channel, such as signal band conversion, amplification, or the like. The RF processor 910 up-converts a baseband signal provided from the modem 920 into an RF band signal and then transmits the RF band signal through an antenna, and down-converts the RF band signal received through the antenna into a baseband signal.

The modem 920 converts the baseband signal to/from a bit-stream according to a physical layer protocol of the system. In data transmission, the modem 920 generates complex symbols by performing coding and modulation on a Tx bit-stream, maps the complex symbols to subcarriers, and configures OFDM symbols by performing an IFFT operation and inserting a CP. In data reception, the modem 920 divides the baseband signal provided from the RF processor 910 in an OFDM symbol unit, restores signals mapped to subcarriers by performing an FFT operation, and then restores an Rx bit-stream by performing demodulation and decoding.

The storage unit 930 stores a basic program for operating the SS, an application program, and data such as user content. The storage unit 930 provides the stored data at the request of the controller 940. In particular, the storage unit 930 stores information for a persistent resource for group data of a service group to which the SS is registered.

The controller 940 provides overall control to the BS. For example, the controller 940 configures downlink data and provides the data to the modem 820, and interprets uplink data provided from the modem 820. The controller 940 also controls a function for receiving periodically generated group data by using the persistent resource as follows.

The controller 940 receives service group information from the BS according to an M2M communication service group registration procedure. The service group information includes an ID of the group and information on an index allocated to the SS in the group. Upon receiving the persistent allocation MAP for the group data of the service group, the controller 940 stores information of the persistent information included in the persistent allocation MAP into the storage unit 930, and receives the group data periodically by using the persistent resource.

After receiving the persistent allocation MAP, if the persistent allocation MAP is received again, the controller 940 determines whether the persistent allocation MAP is a redundantly received persistent allocation MAP. For example, if the information indicating whether current transmission is retransmission is set to a value that indicates retransmission, the controller 940 recognizes the persistent allocation MAP as the redundantly received persistent allocation MAP. If the persistent allocation MAP is the redundantly received persistent allocation MAP, the controller 940 discards the persistent allocation MAP, and if the persistent allocation MAP is a newly received persistent allocation MAP, the controller 940 updates pre-stored persistent allocation information to new persistent allocation information included in the persistent allocation MAP. If retransmission of the persistent allocation MAP is unicast transmission to a specific SS, the aforementioned function of determining whether it is redundant reception and of discarding and updating the persistent allocation information according to the determination result may be omitted.

In order to report to the BS whether the persistent allocation MAP is successfully received, the controller 940 operates as follows. According to a first exemplary embodiment of the present invention, the controller 940 transmits a feedback signal by using feedback information indicated by feedback resource allocation information included in the persistent allocation MAP. Alternatively, according to a second exemplary embodiment of the present invention, the controller 940 receives the group data and thereafter transmits feedback data for the group data.

According to exemplary embodiments of the present invention, a transmission resource for data is allocated in a persistent allocation fashion by considering a case where the same data is periodically transmitted to devices belonging to a group in an M2M communication system, thereby being able to support effective multicast data transmission without having to use a complex broadcast service method or without the increase in a resource allocation overhead.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of operating a Base Station (BS) in a Machine to Machine (M2M) communication system, the method comprising:
determining whether a persistent resource for group data of an M2M communication service group is allocated;
if the persistent resource is not allocated, configuring the persistent resource for the group data and transmitting allocation information for the persistent resource to at least one Subscriber Station (SS) registered to the service group; and
multicasting the group data to the at least one SS by using the persistent resource.

2. The method of claim 1, further comprising:
determining whether the at least one SS successfully receives the allocation information for the persistent resource; and
if the at least one SS does not successfully receive the allocation information for the persistent resource, retransmitting the allocation information for the persistent resource.

3. The method of claim 2, wherein the retransmitting of the allocation information for the persistent resource comprises:
transmitting the allocation information for the persistent resource in a unicast fashion to the at least one SS which does not successfully receive the allocation information for the persistent resource.

4. The method of claim 2, wherein the retransmitting of the allocation information for the persistent resource comprises:
transmitting the allocation information for the persistent resource in a multicast fashion, the allocation information including information for indicating retransmission.

5. The method of claim 2, wherein the determining of whether the at least one SS successfully receives the allocation information for the persistent resource comprises:
if a feedback signal for the allocation information for the persistent resource is not received from the at least one SS registered to the service group, recognizing that the at least one SS does not successfully receive the allocation information for the persistent resource.

6. The method of claim 5, further comprising:
allocating a feedback resource for feedback signal transmission for the allocation information for the persistent resource; and
transmitting allocation information for the feedback resource together with the allocation information for the persistent resource.

7. The method of claim 2, wherein the determining of whether the at least one SS successfully receives the allocation information for the persistent resource comprises:
after multicasting the group data, if the feedback data for the group data is not received from the at least one SS registered to the service group, recognizing that the at least one SS does not successfully receive the allocation information for the persistent resource.

8. The method of claim 1, further comprising:
if a new SS joins the service group, transmitting service group information to the new SS according to a service group registration procedure; and
if the persistent resource for the group data of the service group exists, transmitting the allocation information for the persistent resource to the new SS.

9. The method of claim 8, wherein the service group information includes at least one of an identifier of the service group and an index allocated to identify the SS in the service group.

10. The method of claim 1, wherein the transmitting of the allocation information for the persistent resource to the at least one SS registered to the service group comprises:
encoding the allocation information for the persistent resource into a unique sequence of the service group.

11. The method of claim 1, wherein the transmitting of the allocation information for the persistent resource to the at least one SS registered to the service group comprises:
inserting an identifier of the service group into the allocation information for the persistent resource.

12. A method of operating a Subscriber Station (SS) in a Machine to Machine (M2M) communication system, the method comprising:
receiving service group information according to an M2M communication service group registration procedure;
upon receiving allocation information for a persistent resource for group data of the service group, storing the allocation information for the persistent resource; and
upon arrival of a period including the persistent resource, receiving the group data by using the persistent resource.

13. The method of claim 12, further comprising:
determining allocation information of a feedback resource included in the allocation information for the persistent resource; and
transmitting a feedback signal for the allocation information for the persistent resource by using the feedback resource.

14. The method of claim 12, further comprising:
after receiving the group data, transmitting feedback data for the group data.

15. The method of claim 12, further comprising:
after receiving the allocation information for the persistent resource, upon receiving allocation information for a new persistent resource, determining whether the allocation information for the new persistent resource has already been received; and
if the allocation information for the new persistent resource has already been received, discarding the allocation information for the new persistent resource.

16. The method of claim 15, wherein the determining of whether the allocation information for the new persistent resource is performed based on information which is included in the allocation information for the persistent resource and which indicates whether a current transmission is retransmission.

17. The method of claim 15, wherein the determining of whether the allocation information for the new persistent resource is performed comprises:
comparing contents of the allocation information for the new persistent resource with contents of the allocation information of the previously received persistent resource.

18. The method of claim 12, wherein the service group information includes at least one of an index of the service group and an index allocated to identify the SS in the service group.

19. A Base Station (BS) apparatus in a Machine to Machine (M2M) communication system, the apparatus comprising:
a controller for determining whether a persistent resource for group data of an M2M communication service group is allocated; and
a modem for configuring the persistent resource for the group data if the persistent resource is not allocated, for transmitting allocation information for the persistent resource to at least one Subscriber Station (SS) registered to the service group, and for multicasting the group data to the at least one SS by using the persistent resource.

20. The apparatus of claim 19, wherein the controller determines whether the at least one SS successfully receives the allocation information for the persistent resource, and, if the at least one SS does not successfully receive the allocation information for the persistent resource, the controller retransmits the allocation information for the persistent resource.

21. The apparatus of claim 20, wherein the modem transmits the allocation information for the persistent resource in a unicast fashion to the at least one SS which does not successfully receive the allocation information for the persistent resource.

22. The apparatus of claim 20, wherein the modem transmits the allocation information for the persistent resource in a multicast fashion, the allocation information for the persistent resource including information for indicating retransmission.

23. The apparatus of claim 20, wherein, if a feedback signal for the allocation information for the persistent resource is not received from the at least one SS registered to the service group, the controller recognizes that the at least one SS does not successfully receive the allocation information for the persistent resource.

24. The apparatus of claim 23, wherein the controller allocates a feedback resource for feedback signal transmission for the allocation information for the persistent resource, and transmits allocation information for the feedback resource together with the allocation information for the persistent resource.

25. The apparatus of claim 20, wherein, after multicasting the group data, if the feedback data for the group data is not received from the at least one SS registered to the service group, the controller recognizes that the at least one SS does not successfully receive the allocation information for the persistent resource.

26. The apparatus of claim 19, wherein the modem transmits service group information to the new SS according to a service group registration procedure if a new SS joins the service group, and transmits the allocation information for the persistent resource to the new SS if the persistent resource for the group data of the service group exists.

27. The apparatus of claim 26, wherein the service group information includes at least one of an identifier of the service group and an index allocated to identify the SS in the service group.

28. The apparatus of claim 19, wherein the modem encodes the allocation information for the persistent resource into a unique sequence of the service group.

29. The apparatus of claim 19, wherein the controller inserts an identifier of the service group into the allocation information for the persistent resource.

30. A Subscriber Station (SS) apparatus in a Machine to Machine (M2M) communication system, the apparatus comprising:
a modem for receiving service group information according to an M2M communication service group registration procedure;
a storage unit for storing allocation information for a persistent resource upon receiving the allocation information for the persistent resource for group data of the service group; and
a controller for receiving the group data by using the persistent resource upon arrival of a period including the persistent resource.

31. The apparatus of claim 30, wherein the controller determines allocation information of a feedback resource included in the allocation information for the persistent resource, and transmits a feedback signal for the allocation information for the persistent resource by using the feedback resource.

32. The apparatus of claim 30, wherein, after receiving the group data, the controller transmits feedback data for the group data.

33. The apparatus of claim 30, wherein, after receiving the allocation information for the persistent resource, upon receiving allocation information for a new persistent resource, the controller determines whether the allocation information for the new persistent resource has already been received, and, if the allocation information for the new persistent resource has already been received, discards the allocation information for the new persistent resource.

34. The apparatus of claim 33, wherein the controller determines whether the allocation information for the new persistent resource has already been received based on information which is included in the allocation information for the persistent resource and which indicates whether current transmission is retransmission.

35. The apparatus of claim 33, wherein the controller determines whether the allocation information for the new persistent resource has already been received based on a comparison of contents of the allocation information for the new persistent resource with contents of the allocation information of the previously received persistent resource.

36. The apparatus of claim 30, wherein the service group information includes at least one of an index of the service group and an index allocated to identify the SS in the service group.
